(19) United States
(12) Patent Application Publication
(10) Pub. No.: US 2024/0202611 A1
(43) Pub. Date: Jun. 20, 2024

(54) BLOCKCHAIN TRANSACTIVE ENERGY MANAGEMENT SYSTEM

(71) Applicant: IEMS Solution Ltd, Kitchener (CA)

(72) Inventors: Ashkan Rahimi-Kian, Kitchener (CA); Masoud Bashari, Kitchener (CA); Javad Zare, Kitchener (CA); Ehsan Saradar-Torshizi, Kitchener (CA); Kaveh Aflaki, Suwanee, GA (US)

(73) Assignee: IEMS Solution Ltd, Kitchener (CA)

(21) Appl. No.: 18/511,912

(22) Filed: Nov. 16, 2023

Related U.S. Application Data
(60) Provisional application No. 63/432,422, filed on Dec. 14, 2022.

(51) Int. Cl. G06Q 10/04; G05B 19/042; G06Q 50/06

(52) U.S. Cl. CPC G06Q 10/04; G05B 19/042; G06Q 50/06; G05B 2219/2639

(57) ABSTRACT

A transactive energy platform includes a blockchain service engine connected to a distribution system operator software agent, a driver software agent, an electric vehicle servicing entities software agent, and a demand response software agent. A physical network simulator platform connects to at least one charging station. A demand response dashboard and a distribution system operator dashboard is provided. An analytics engine includes at least one forecast engine connected to at least one database. The blockchain service engine is configured to communicate with the software agents and generate and manage smart contracts, based on inputs from the forecast engines and metered data from the physical network simulator platform.

### CROSS REFERENCE TO RELATED APPLICATION

This application claims the benefit under 35 U.S.C. § 119(e) of co-pending U.S. Provisional Application No. 63/432,422 entitled “BLOCKCHAIN TRANSACTIVE ENERGY MANAGEMENT SYSTEM” filed Dec. 14, 2022, which is incorporated herein by reference.

### BACKGROUND

With the growth of distributed renewable energy resources, electric vehicle (EV) charging stations and EV-fleets are experiencing a corresponding need for new resources and expanded loads. The need to connect to the power distribution grids increases over time. Unfortunately, existing software as a service (SaaS) infrastructure is not capable of simultaneously handling data collection, predictive analytics, real-time optimization and control of new energy resources and loads. Accordingly, improved SaaS infrastructure that can address these issues is needed.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a blockchain transactive energy management system is provided. A transactive energy platform includes a blockchain service engine connected to a distribution system operator software agent, a driver software agent, an electric vehicle servicing entities software agent, and a demand response software agent. A physical network simulator platform connects to at least one charging station. A demand response dashboard and a distribution system operator dashboard is provided. An analytics engine includes at least one forecast engine connected to at least one database. The blockchain service engine is configured to communicate with the software agents and generate and manage smart contracts, based on inputs from the forecast engines and metered data from the physical network simulator platform.

In other implementations, a blockchain transactive energy management method is provided. A transactive energy platform is provided including a blockchain service engine connected to a distribution system operator software agent, a driver software agent, an electric vehicle servicing entities software agent, and a demand response software agent. A physical network simulator platform is connected to at least one charging station. A demand response dashboard and a distribution system operator dashboard are connected to the transactive energy platform. An analytics engine including at least one forecast engine connected to at least one database is utilized to generate forecast data based on historical data from the database. A blockchain service engine is utilized to communicate with the software agents and generate and manage smart contracts, based on inputs from the forecast engines and metered data from the physical network simulator platform.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is an embodiment of blockchain transactive energy application platform.

FIGS. 2A-2D illustrate an exemplary activity program for the transactive energy management system in the blockchain transactive energy application.

FIG. 3 is an exemplary blockchain architecture of the disclosed platform.

FIG. 4 is an exemplary structure of the data engineering and machine learning engineering components associated with the disclosed blockchain system.

FIG. 5 is a block diagram of a cloud-based computing system operable to execute the disclosed systems and methods in accordance with this disclosure.

FIG. 6 is a block diagram of a computing system operable to execute the disclosed systems and methods in accordance with this disclosure.

### DETAILED DESCRIPTION

A blockchain transactive energy system that utilizes a blockchain-based market platform on web and mobile is disclosed. The platform incorporates both web and mobile device capable application programmed interfaces (API). The disclosed platform provides connected learning software agents for issuing bids and/or offers, negotiations, e-contract signing, and financial settlement within the blockchain platform. In an exemplary embodiment, the blockchain platform is implemented through a COSMOS blockchain platform. The disclosed platform provides smart contracts for transactive energy management. In operation, the smart contract performs pre-agreement to handle negotiations between parties (offer and acceptance) before binding into a contract. The smart contract specifies the terms and conditions of a legal contract, monitors the state of obligations and legal rights, and enables any of the pertinent functions in transactive energy management.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

A transactive energy (TE) platform can be implemented within the cloud computing platforms for smart-grids with vehicle-to-grid (V2G) and grid-to-vehicle (G2V) services. The platform improves the electric distribution network reliability, stability, efficiency. The platform can help grid operators make the power network more environment friendly by significantly reducing greenhouse gas via optimal utilization of clean energy resources. Further, the disclosed platform provides financial benefits for the EV drivers, EV serving entities (EVSE), and demand response (DR) aggregators. In various embodiments, the disclosed software architecture is scalable, secure, and deployable within all cloud platforms (i.e., AWS, MS Azure, Google and IBM).

The disclosed platform includes a hybrid neural network model with long short-term memory (LSTM) and deep feedforward network (DFNN) for forecasting electric load and photovoltaic (PV) generation by using historical, meteorological and irradiation parameters. The disclosed platform further includes fast and normal EV charging stations that are completely compatible with existing EV batteries; third, scalable Proof of Reputation (POR) energy blockchain with off-chain Know-Your-Customer (KYC); and finally, two-level Stackelberg game (or leader-follower game) formulation and optimization to find the stable Economic Game equilibrium between the grid operator and energy aggregators; and that for the energy aggregators and prosumers.

Using a hierarchical model, the Stackelberg (or leader-follower) game gives the followers the ability to negotiate with the leaders on the offered attributes to get their desired profits. The followers in various embodiments can include electric vehicle service entities, demand response aggregators, and electric car drivers. The leaders, in various embodiments, can include distribution system operators (DSO) and electric vehicle service entity (EVSE) aggregators. The offered attributes can be energy, price, time duration, or a combination of any of the relevant factors.

When the DSO submits an offer to DR and/or EVESE aggregator, the follower can accept, reject, or send a counteroffer to the leader (i.e., DSO). The leader in return replies by an accept or reject signal. Each transactive energy management (TEM) participant (leader or follower in the energy trade game) has an intelligent bidding agent that uses the TEM market rules, historical market prices, electric demands and energy trades and the objective function of its owner to optimize the attribute offer to the other party (i.e., DSO or EVSE) that needs its energy in a near future. The attribute offered can be energy, price, time duration, or a combination.

In some embodiments, the disclosed system utilizes state of the art blockchain platforms to model and develop a peer-to-peer (P2P) energy trading network that each stakeholder can communicate directly. In addition, the stakeholders can vote on validating a transaction (using proof of authority consensus) and adding a new agent to the network. In one embodiment, the blockchain platform is a Cosmos Blockchain platform. The disclosed platform provides a real-time automated distributed energy resources management systems controlling model as well as secure and robust energy trading model. The disclosed platform has high scalability with respect to the number of distributed energy resources, demand responses, electric vehicle service entities and electric vehicles in the transactive energy platform. The platform is implemented to manage assigned tasks without centralized supervision, use smart contracts for tracking and checking enrolled prosumers' compliance, and issue electronic ledgers for financial settlements among stakeholders.

The disclosed platform incorporates evolving smart grids with numerous applications such to help the distribution system operators to function with more efficiency, cyber-security, reliability, and resiliency. The disclosed platform enables distribution system operators to trade with the energy prosumers (or owners of the DER, DR and EV-fleet) using an autonomous and distributed energy market platform.

The numerous operations can include DER integration & interoperability with the bulk power systems, DER, DR and EV-fleet hourly (or sub-hourly) prediction and optimization.

Currently, there is no commercial SaaS/software solution that can efficiently address the above-mentioned issues for the regional Electricity System Operators (ISO, TSO, IESO), Power Utilities (PUs), Microgrid developers and operators, net-zero community developers and energy managers. The disclosed total SaaS/software solution can optimally and efficiently address the above-mentioned issues for the major Smart Grid stakeholders.

The blockchain transactive energy system is disclosed within the environment that includes a blockchain-based market platform on web and mobile. The platform incorporates both web and mobile device capable application programmed interfaces (API). The platform provides connected learning software agents for issuing bids and/or offers, negotiations, e-contract signing, and financial settlement within the blockchain platform. In an exemplary embodiment, the blockchain platform is implemented through a COSMOS blockchain platform.

The platform provides smart contracts for transactive energy management. In operation, the smart contract performs pre-agreement to handle negotiations between parties (offer and acceptance) before binding into a contract. The smart contract specifies the terms and conditions of a legal contract, monitors the state of obligations and legal rights, and enables any of the pertinent functions in transactive energy management.

The platform uses blockchain methodology to store smart contract transactions in a permissioned and configurable distributed ledger. The platform provides scalable Proof of Reputation (POR) energy blockchain with off-chain Know-Your-Customer (KYC).

The platform utilizes two-level Stackelberg game or leader-follower game) formulation and optimization to find the stable Economic Game equilibrium between the grid operator and energy aggregators; and also, for the energy aggregators and prosumers (EV drivers, net-zero buildings, solar PV & wind farms, EVSE).

The platform is implemented throughs state of the art blockchain technology to support energy trading network that each stakeholder can communicate directly and vote on validating a transaction (using proof of authority consensus) and adding a new agent to the network.

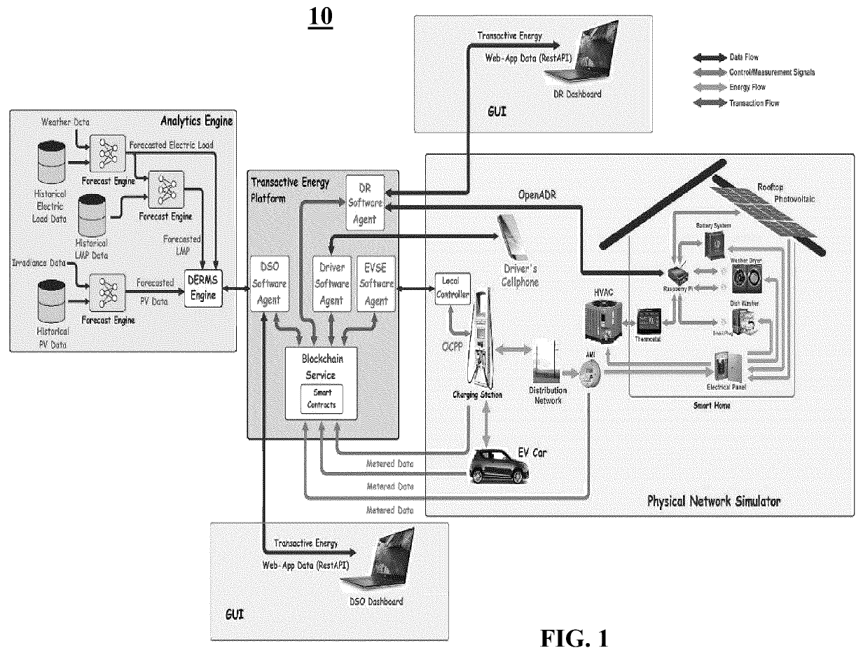

Referring to the drawing and, in particular to FIG. 1, an embodiment of the transactive energy management system, generally designated by the numeral 10, is illustrated. In an overview, the blockchain chain transactive energy system comprises a transactive energy platform, a physical network simulator, an analytics engine, and a number of graphic user interfaces for various users.

The transactive energy platform comprises a blockchain service module along with a number of software agents. The blockchain service is configured to host smart contracts, which are used to coordinate energy resource exchange functions between various stakeholders. In various embodiments, the transactive energy platform can comprise demand response software agents, distribution service operator software agents, driver software agents, and electric vehicle service entity software agents. The various software agents can be implemented to interact with the other components of the platform, as will be described subsequently. Each of the software agents is connected to the blockchain service module, which is configured to facilitate communication, negotiation, assignment, and management of smart contracts among the software agents. In other embodiments, it is foreseeable that additional software agents can be implemented on the transactive energy platform in conjunction with the blockchain service module.

The distribution service operator software agent is connected to an analytical engine, which is used to generate predicative analysis for the management of distribution resources within the network. The analytics engine can be implemented as a part of a distribution energy resources management services (DERMS) software engine. The DERMS software can generate forecast data for a number of application specific parameters. In the exemplary embodiment, the DERMS engine is configured to perform forecast analytics on electric load, locational marginal pricing (LMP), and photovoltaic (PV) data.

In the exemplary embodiment, a forecast engine is implemented for each of the forecast analysis data. A forecast engine dedicated to forecasted electric load is configured to receive as inputs weather data and historical electric load data. The forecast engine preforms predicative analysis based on the inputs and generates a forecast output to the DERMS engine. The DERMS engine subsequently transfers the forecast data to the distribution service operator software agent on the transactive platform. The process is similarly implemented for forecasted photovoltaic (PV) data, wherein a forecast engine receives as inputs irradiance data and historical photovoltaic data and generates forecast output data. In the case of the locational marginal pricing, the associated forecast engine would receive as input a set of historical LMP data and analyze it against the forecasted electric load data from the other forecast engine. It is foreseeable that users can configure the analytics engine to perform forecast analysis on various additional data fields.

The distribution service operator software agent is further connected to a distribution service operator dashboard on a computer on the network. The DSO dashboard can be used to access transactive energy management through the platform via a graphic user interface. The graphic user interface can facilitate data transfer between the platform and the dashboard through web-app data.

The system incorporates a physical network simulator, such that real world data can be connected, analyzed, and generated concurrently. In the exemplary embodiment, a network of smart capable devices is interconnected according to the needs to the stakeholders. Such physical devices can include electric vehicles, charging stations, and smart homes connected through a distribution network and advanced metering infrastructure (AMI). The smart home further comprises smart home capable devices within, such as photovoltaic rooftop, HVAC system, electric panel, and a plethora of appliances. The smart home owner can further connect the appliances through a personal computing device or mobile phone, which can function as a linked device for the user's electric vehicles.

The demand response software agent of the transactive energy platform can be connected through a network to the smart home mobile device. In the exemplary embodiment, the connection can be implemented as compliant with open automated demand response (OpenADR). The demand response software agent can further be connected to a graphic user interface of a demand response dashboard software, accessible through a computer by a distributed resource operator. The operator can access and manage web-app data of the relevant transactive energy system.

The blockchain service module receives metered data from the charging stations, electric vehicles, and advanced metering infrastructure. Smart contracts are generated and applied to the relevant energy distribution channels to ensure efficient energy distribution performances. Further, an electric vehicle service entity software agent can be connected to a local controller for the charging station, such that the blockchain service module can generate the appropriate instructions for the charging station in order to distribute appropriately metered energy output.

Through the network, connections can be classified as data flow, control/measurement signals, energy flow, and transaction flow. Data flow is created between user devices and monitoring devices to share user oriented data. Control/measurement signals are shared between distributed resource management platforms and devices to distribute appropriately metered energy. Energy flow is connected to covey energy consumption recorded through smart devices in electric vehicles and smart homes. And finally, transaction flow are enabled in the software agents and the blockchains service module, wherein the blockchain service transactive energy platform functions to effectively manage demand and supply over a distribution network in a decentralized manner.

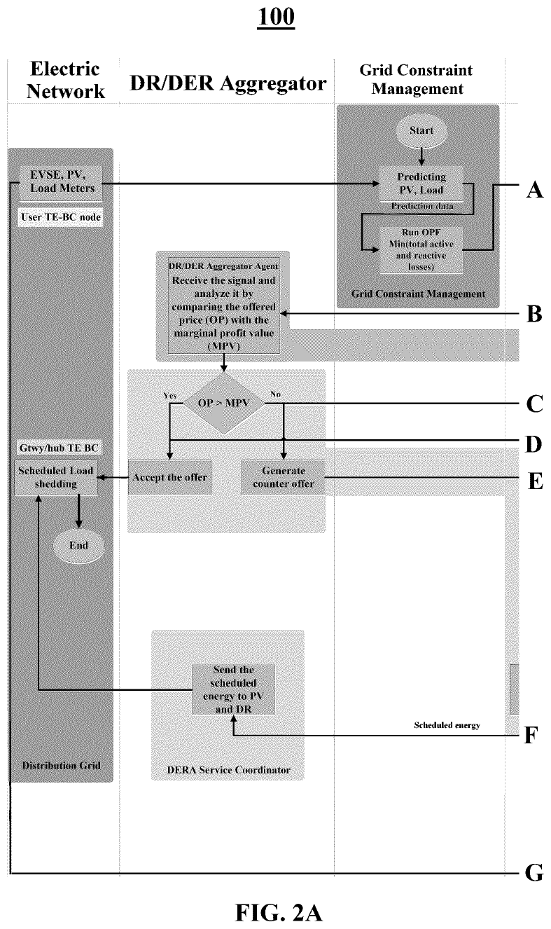

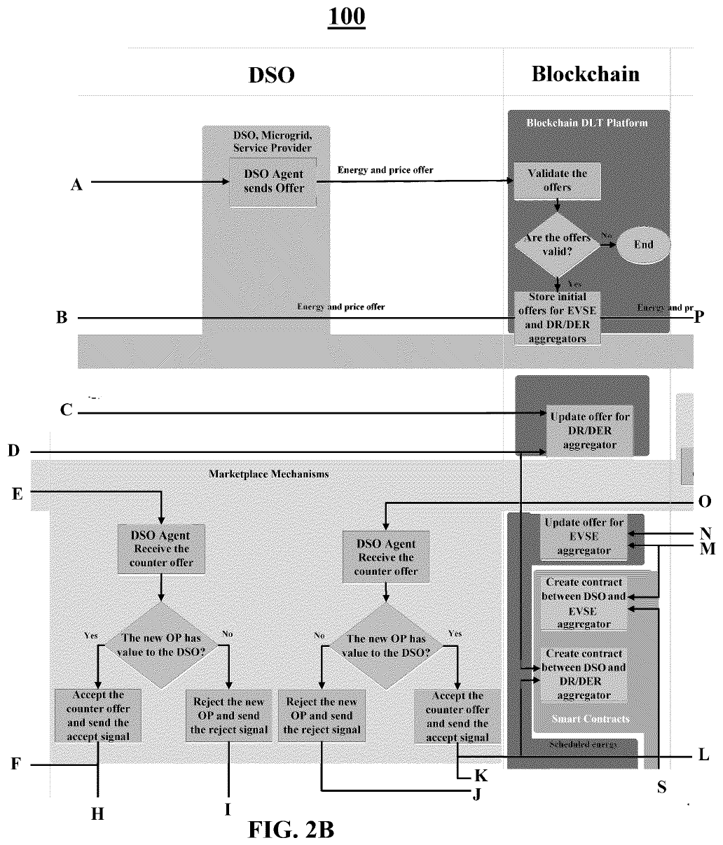

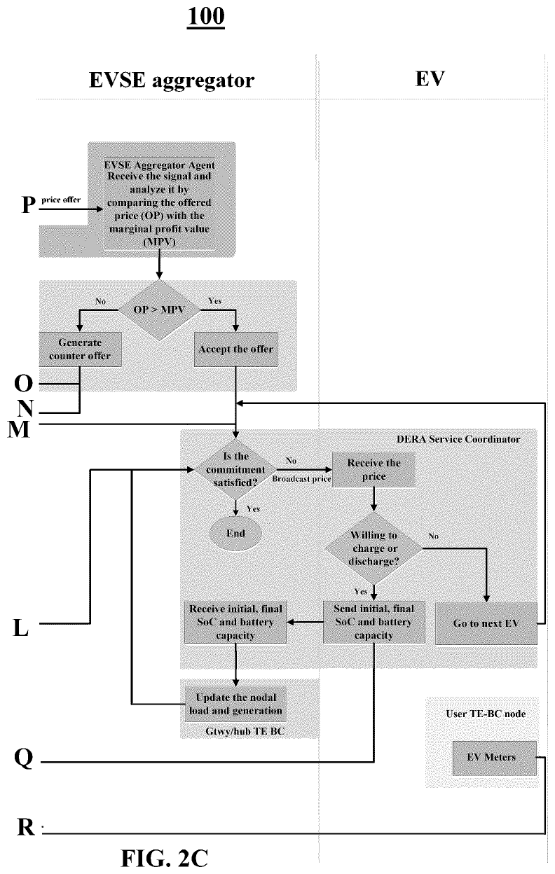

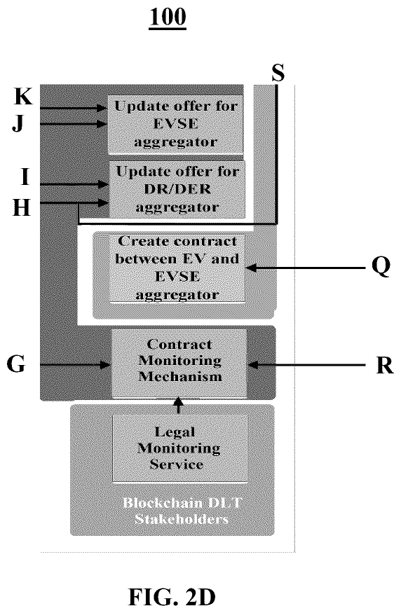

Referring to FIGS. 2A-2D with continuing reference to the foregoing figure, an exemplary activity program, generally designated with the numeral 100, for the blockchain transactive energy platform is shown. The activity program can be implemented in the blockchain service engine as in FIG. 1. The exemplary activity program comprises the following sections: electric network, demand response/distributed energy resources aggregator, grid constraint management, distributed system operator, blockchain, electric vehicle service aggregator, and electric vehicle.

In an exemplary process, the blockchain transactive energy platform, using the meters' data, provides forecasted values for the photovoltaic generation and electric loads, via the forecasting engine. The forecasted values are used by the distributed resource management system (DERMS) engine to run the optimal power flow (OPF) for the distribution system operator (DSO).

Next, the DSO sends an initial offer. In various embodiments, the initial offer can relate to energy, price, or time duration. The initial offer is validated by the blockchain and transferred to the electric vehicle serving entity (EVSE) aggregator and demand response (DR) aggregator. The DR aggregator agent evaluates the offer by solving a lead-follower game. In the exemplary embodiment, the leader-flower game is a Stackleberg game. Based on the game equilibrium outcome, the DR aggregator agent then accepts, rejects, or counter-offers the option to the distribution system operator. The counter-offer is evaluated and finalized by the distribution system operator agent. The final decision on the offer, related to energy, price, or time duration, is registered within the blockchain. The accepted offer with the final energy or time duration schedules are submitted to the DR agent for execution in time.

Similar to the DR aggregator, the EVSE aggregator agent evaluates the DSO offer by solving a leader-follower game. In the exemplary embodiment, the leader-follower game is a Stackleberg game. Based on the game equilibrium outcome, the EVSE aggregator agent has the option to accept, reject, or make a counter offer. The counter offer is in turn evaluated and finalized by the DSO agent. The final decision on the offer is registered within the blockchain. The accepted offer with final energy or time duration schedules are submitted to the EVSE agent for execution in time.

The optimal and profitable contract/offer for the EVSE is broadcasted to the registered electric vehicle drivers. Each EV driver's agent evaluates the EVSE offer and make a decision to accept or reject the offer. Should the EV driver agent reject the of EVSE offer, the EV driver will be out of the loop. Should the EV driver agent accepts the EVSE offer, the electronic transactive energy contract will be issued within the blockchain transactive energy platform. The state of charge (SOC) and its tendency to charge (G2V) or discharge (V2G) are reported to EVSE aggregator. The process repeats and continues until the EVSE aggregator's commitment to the DSO is satisfied.

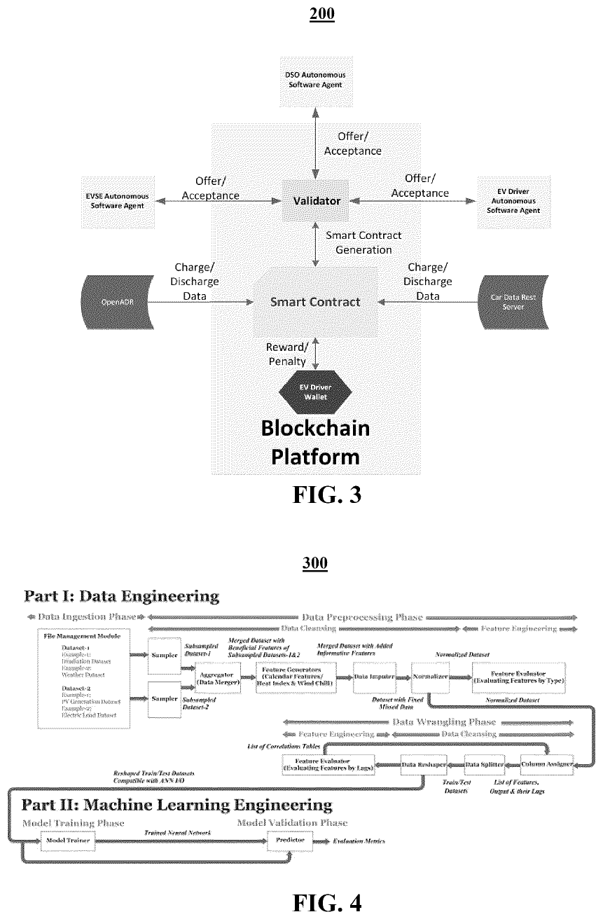

Referring now to FIG. 3 with continuing reference to the foregoing figures, blockchain platform architecture, generally designated with the numeral 200, is illustrated. Central to the platform is the formation and management of smart contracts in relation to the interests and requirements of various stakeholders. In the exemplary embodiment, the stakeholders can be electric vehicle serving entities (EVSE), distribution system operators (DSO), and electric vehicle (EV) drivers. Each of the stakeholder will have an autonomous software agent associated. The EVSE autonomous software agent, DSO autonomous software agent, and EV driver autonomous software agent are connected to a validator within the blockchain platform. As described in the activity diagram in FIGS. 2A-2D, each of the software agent is capable to managing offer and acceptance from the blockchain platform.

Smart contract generation is enabled through the smart contract module. The smart contract module is configured to interact with the various autonomous software agents through the validator module, such that a decentralized distribution planning and managing methodology can be carried out automatically in various embodiments.

The smart contract module also receive charge/discharge data in the network from car data rest server and open automated demand response (OpenADR). With the input from these sources, proper smart contracts are generated in relation to the stakeholder's respective autonomous software agent. The resulting energy distribution and cost assignment from the accepted offers and smart contracts result in change in the value of electric vehicle driver's wallet. In an exemplary embodiment, the electric vehicle driver wallet

In an exemplary embodiment, the blockchain transactive energy (BCTE) platform API is called for a specific data/time by the user. The user accesses the BCTE platform through the various graphic user interface through the driver's cellphone or dashboards. The respective automated software agents for the user and the corresponding DSO/DR stakeholders access the blockchain platform after communicating with the validator.

The DSO automated software agent gets the forecasted values of electric load, locational marginal price, and solar-photovoltaic for the selected date/time. The DSO agent uses DERMS Engine to calculate the EVSE and VPP demand response (DR) contributions to resolve the grid assets' congestions. The DSO agent generates the DR offers based on the DERMS results. The DSO agent sends the DR offers to EVSE and VPP aggregator agents through blockchain. The EVSE and VPP aggregator agents receive the DR offers, evaluate them and decide to submit accept, reject, or counteroffer signals back to the DSO agent. The DSO agent finalizes the DR signals from the EVSE and VPP aggregator agents, and the corresponding “smart contracts” are automatically generated. The EVSE and VPP aggregator agents send the new control set-points to the local controllers of EV chargers and flexible loads, i.e., date, start-time, stop-time, load amount, or EV charger capacity.

Finally, the “smart contracts” monitor the EV chargers and loads energy consumptions for blogs/reports to the DSO agent and financial settlements via blockchain platform.

Referring to FIG. 4 with continuing reference to the foregoing figures, an exemplary structure, generally designated by the numeral 300, for data and machine learning engineering associated with the distributed energy resources management system is illustrated. The structure 300 can be implemented by the software engine to facilitate the forecasting function. In various embodiments, data engineering would be implemented to provide input data and parameters for artificial neural network training methodologies.

In general, data engineering aspect of the disclosed system would function through a number of phases. In an exemplary embodiment, data engineering comprises data ingestion phase, data processing phase, and data wrangling phase. The data process phase can further comprise of data cleansing and feature engineering. The data wrangling phase further incorporate feature engineering and data cleansing.

In the data ingestion phase, a file management module is provided. This can be implemented as a standalone database or as a part of a comprehensive database in larger system. FIG. 4 illustrates a number of datasets that could be stored in this management module. The dataset can be used to store and provide input for data used by the analytic engine in FIG. 1.

The data from the file management module can be extracted to go through the data process phase. In this exemplary phase, the data can go be processed through a data cleansing step. During this procedure, at least one sampler from a dataset in the file management module is collected by an aggregator or data merger. The aggregator provides the function to merge a number of datasets with their beneficial features.

Next, the merged datasets will be merged further with added informative features. This can be achieved by features generators. In this embodiment, the features generator can generate features on calendar features, heat index, and wind chill. The merged database with added informative features is processed through a data imputer and a normalizer. At this step, the datasets are transformed into normalized datasets. Finally, the normalized dataset is processed through a feature engineering step. In the exemplary embodiment, a feature evaluator is provided to evaluate the features incorporated into the normalized dataset. The resultant data would be ready for further predicative processing in the software engine.

### Exemplary Cloud Architecture

Referring to FIG. 5 with continuing reference to the foregoing figures, exemplary cloud architecture, generally designated by the numeral 400, for implementing the system 10 shown in FIG. 1, the program 100 shown in FIGS. 2A-2D, the blockchain architecture 200 shown in FIG. 3 and/or the structure 300 shown in FIG. 4. The exemplary cloud architecture 400 provides computation, software, data access, and storage services that do not require end-user knowledge of the physical location or configuration of the system that delivers the services. In various embodiments, cloud computing delivers the services over a wide area network, such as the internet, using appropriate protocols.

For instance, cloud computing providers deliver applications over a wide area network and they can be accessed through a web browser or any other computing component. Software or components of architecture 400 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud can be managed by the organization itself and the infrastructure is typically not shared with other organizations. The organization still maintains the hardware to some extent, such as installations and repairs, etc.

As shown in FIG. 5, the cloud architecture 400 includes a cloud 410. The cloud 410 (or each of the different premises on the cloud 410) can include a hardware layer 412, an infrastructure layer 414, a platform layer 416, and an application layer 418.

A hypervisor 420 can illustratively manage or supervise a set of virtual machines 422 that can include a plurality of different, independent, virtual machines 424-426. Each virtual machine can illustratively be an isolated software container that has an operating system and an application inside it. It is illustratively decoupled from its host server by hypervisor 420. In addition, hypervisor 420 can spin up additional virtual machines or close virtual machines, based upon workload or other processing criteria.

A plurality of different client systems 428-430 (which can be end user systems or administrator systems, or both) can illustratively access cloud 410 over a network 432. Depending upon the type of service being used by each of the client systems 428-430, cloud 410 can provide different levels of service. In one example, the users of the client systems are provided access to application software and databases. The cloud service then manages the infrastructure and platforms that run the application. This can be referred to as software as a service (or SaaS). The software providers operate application software in application layer 418 and end users access the software through the different client systems 428-430.

The cloud provider can also use platform layer 416 to provide a platform as a service (PaaS). This involves an operating system, programming language execution environment, database and webserver being provided to the client systems 428-430, as a service, from the cloud provider. Application developers then normally develop and run software applications on that cloud platform and the cloud provider manages the underlying hardware and infrastructure and software layers.

The cloud provider can also use infrastructure layer 414 to provide infrastructure as a service (IaaS). In such a service, physical or virtual machines and other resources are provided by the cloud provider, as a service. These resources are provided, on-demand, by the IaaS cloud provider, from large pools installed in data centers. In order to deploy the applications, the cloud users that use IaaS install operating-system images and application software on the cloud infrastructure 400.

### Exemplary Computer System

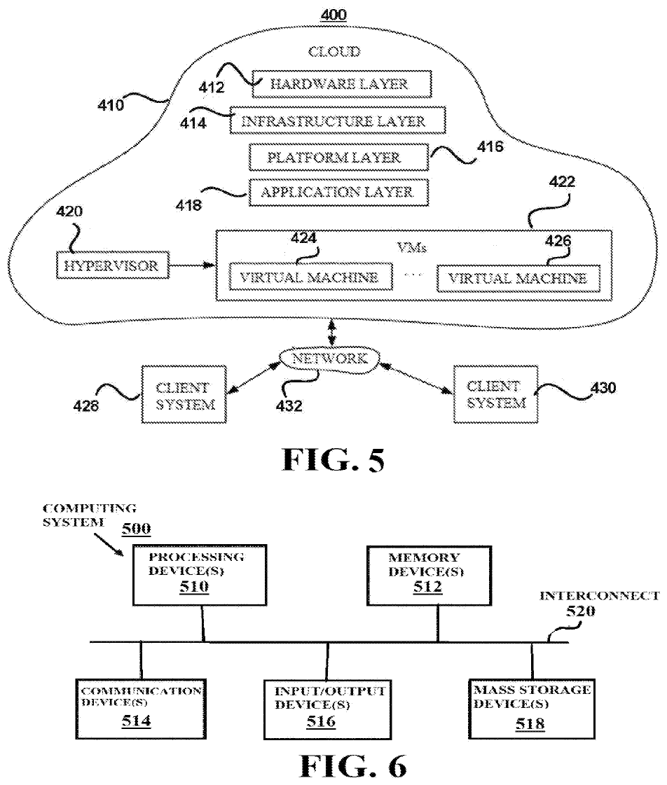

Referring now to FIG. 6 with continuing reference to the forgoing figures, an exemplary computing system, generally designated by the numeral 500, for use implementing aspects of the system 10 shown in FIG. 1, the program 100 shown in FIGS. 2A-2D, the blockchain architecture 200 shown in FIG. 3 and/or the structure 300 shown in FIG. 4 is shown. The hardware architecture of the computing system 500 that can be used to implement any one or more of the functional components described herein. In some embodiments, one or multiple instances of the computing system 500 can be used to implement the techniques described herein, where multiple such instances can be coupled to each other via one or more networks.

The illustrated computing system 500 includes one or more processing devices 510, one or more memory devices 512, one or more communication devices 514, one or more input/output (I/O) devices 516, and one or more mass storage devices 518, all coupled to each other through an interconnect 520. The interconnect 520 can be or include one or more conductive traces, buses, point-to-point connections, controllers, adapters, and/or other conventional connection devices. Each of the processing devices 510 controls, at least in part, the overall operation of the processing of the computing system 500 and can be or include, for example, one or more general-purpose programmable microprocessors, digital signal processors (DSPs), mobile application processors, microcontrollers, application-specific integrated circuits (ASICs), programmable gate arrays (PGAs), or the like, or a combination of such devices.

Each of the memory devices 512 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Each mass storage device 518 can be or include one or more hard drives, digital versatile disks (DVDs), flash memories, or the like. Each memory device 512 and/or mass storage device 518 can store (individually or collectively) data and instructions that configure the processing device(s) 510 to execute operations to implement the techniques described above.

Each communication device 514 can be or include, for example, an Ethernet adapter, cable modem, Wi-Fi adapter, cellular transceiver, baseband processor, Bluetooth or Bluetooth Low Energy (BLE) transceiver, serial communication device, or the like, or a combination thereof. Depending on the specific nature and purpose of the processing devices 510, each I/O device 516 can be or include a device such as a display (which can be a touch screen display), audio speaker, keyboard, mouse or other pointing device, microphone, camera, etc. Note, however, that such I/O devices 516 can be unnecessary if the processing device 510 is embodied solely as a server computer.

In the case of a client device, the communication devices(s) 514 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, the communication device(s) 514 can be or include, for example, any of the aforementioned types of communication devices, a wired Ethernet adapter, cable modem, DSL modem, or the like, or a combination of such devices.

A software program or algorithm, when referred to as “implemented in a computer-readable storage medium,” includes computer-readable instructions stored in a memory device (e.g., memory device(s) 512). A processor (e.g., processing device(s) 510) is “configured to execute a software program” when at least one value associated with the software program is stored in a register that is readable by the processor. In some embodiments, routines executed to implement the disclosed techniques can be implemented as part of OS software (e.g., MICROSOFT WINDOWS® and LINUX®) or a specific software application, algorithm component, program, object, module, or sequence of instructions referred to as “computer programs.”

Computer programs typically comprise one or more instructions set at various times in various memory devices of a computing device, which, when read and executed by at least one processor (e.g., processing device(s) 510), will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium (e.g., the memory device(s) 512).

The detailed description provided above in connection with the appended drawings is intended as a description of examples and is not intended to represent the only forms in which the disclosed examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

### Supported Features and Embodiments

The detailed description provided above in connection with the appended drawings explicitly describes and supports various features of an blockchain transactive energy management system. By way of illustration and not limitation, supported embodiments include a blockchain transactive energy management system comprising: a transactive energy platform including a blockchain service engine connected to a distribution system operator software agent, a driver software agent, an electric vehicle servicing entities software agent, and a demand response software agent, a physical network simulator platform connected to at least one charging station, a demand response dashboard, a distribution system operator dashboard, and an analytics engine including at least one forecast engine connected to at least one database, wherein the blockchain service engine is configured to communicate with the software agents and generate and manage smart contracts, based on inputs from the forecast engines and metered data from the physical network simulator platform.

Supported embodiments include the foregoing system, wherein the physical network simulator platform further comprises at least one distribution network, one smart home network, and one advanced metering infrastructure.

Supported embodiments include any of the foregoing systems, wherein the distribution system operator dashboard communicates transactive energy web app data to the distribution system operator agent.

Supported embodiments include any of the foregoing systems, wherein the demand response dashboard communicates transactive energy web app data to the demand response software agent.

Supported embodiments include any of the foregoing systems, wherein the blockchain service engine comprises a smart contract module, which is configured to generate at least one smart contracts for each of the software agent based on metered data from the physical network simulator, wherein the software agents are configured to accept, reject, or counter offer the smart contracts.

Supported embodiments include a blockchain transactive energy management method comprising: providing a transactive energy platform including a blockchain service engine connected to a distribution system operator software agent, a driver software agent, an electric vehicle servicing entities software agent, and a demand response software agent, connecting a physical network simulator platform connected to at least one charging station, connecting a demand response dashboard and a distribution system operator dashboard to the transactive energy platform, utilizing an analytics engine including at least one forecast engine connected to at least one database to generate forecast data based on historical data from the database, and utilizing a blockchain service engine to communicate with the software agents and generate and manage smart contracts, based on inputs from the forecast engines and metered data from the physical network simulator platform.

Supported embodiments include the foregoing method, wherein the physical network simulator platform further comprises at least one distribution network, one smart home network, and one advanced metering infrastructure.

Supported embodiments include any of the foregoing methods, wherein the distribution system operator dashboard communicates transactive energy web app data to the distribution system operator agent.

Supported embodiments include any of the foregoing methods, wherein the demand response dashboard communicates transactive energy web app data to the demand response software agent.

Supported embodiments include any of the foregoing methods, wherein the blockchain service engine includes a smart contract module, which is configured to generate at least one smart contracts for each of the software agent based on metered data from the physical network simulator, wherein the software agents are configured to accept, reject, or counter offer the smart contracts.

Supported embodiments include an apparatus, a device, a computer-readable storage medium, a computer program product and/or means for implementing any of the foregoing systems, methods, or portions thereof.

The detailed description provided above in connection with the appended drawings is intended as a description of examples and is not intended to represent the only forms in which the disclosed examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A blockchain transactive energy management system comprising:
a transactive energy platform including a blockchain service engine connected to a distribution system operator software agent, a driver software agent, an electric vehicle servicing entities software agent, and a demand response software agent,
a physical network simulator platform connected to at least one charging station,
a demand response dashboard,
a distribution system operator dashboard, and
an analytics engine including at least one forecast engine connected to at least one database,
wherein the blockchain service engine is configured to communicate with the software agents and generate and manage smart contracts, based on inputs from the forecast engines and metered data from the physical network simulator platform.

2. The system of claim 1, wherein the physical network simulator platform further comprises at least one distribution network, one smart home network, and one advanced metering infrastructure.

3. The system of claim 1, wherein the distribution system operator dashboard communicates transactive energy web app data to the distribution system operator agent.

4. The system of claim 1, wherein the demand response dashboard communicates transactive energy web app data to the demand response software agent.

5. The system of claim 1, wherein the blockchain service engine comprises a smart contract module, which is configured to generate at least one smart contracts for each of the software agent based on metered data from the physical network simulator, wherein the software agents are configured to accept, reject, or counter offer the smart contracts.

6. A blockchain transactive energy management method comprising:
providing a transactive energy platform including a blockchain service engine connected to a distribution system operator software agent, a driver software agent, an electric vehicle servicing entities software agent, and a demand response software agent,
connecting a physical network simulator platform connected to at least one charging station,
connecting a demand response dashboard and a distribution system operator dashboard to the transactive energy platform,
utilizing an analytics engine including at least one forecast engine connected to at least one database to generate forecast data based on historical data from the database, and
utilizing a blockchain service engine to communicate with the software agents and generate and manage smart contracts, based on inputs from the forecast engines and metered data from the physical network simulator platform.

7. The method of claim 6, wherein the physical network simulator platform further comprises at least one distribution network, one smart home network, and one advanced metering infrastructure.

8. The method of claim 6, wherein the distribution system operator dashboard communicates transactive energy web app data to the distribution system operator agent.

9. The method of claim 6, wherein the demand response dashboard communicates transactive energy web app data to the demand response software agent.

10. The method of claim 6, wherein the blockchain service engine includes a smart contract module, which is configured to generate at least one smart contracts for each of the software agent based on metered data from the physical network simulator, wherein the software agents are configured to accept, reject, or counter offer the smart contracts.
